(19) United States
(12) Patent Application Publication
(10) Pub. No.: US 2026/0088628 A1
(43) Pub. Date: Mar. 26, 2026

(54) ENERGY STORAGE SYSTEM AND ENERGY STORAGE BANK INPUTTING METHOD

(71) Applicant: GS Yuasa International Ltd., Kyoto-shi, Kyoto (JP)

(72) Inventor: Takafumi AKAGI, Kyoto-shi, Kyoto (JP)

(21) Appl. No.: 19/113,800

(22) PCT Filed: Sep. 28, 2023
(86) PCT No.: PCT/JP2023/035338

§ 371 Date: Mar. 20, 2025

(30) Foreign Application Priority Data
Sep. 29, 2022 (JP) 2022-155976

(51) Int. Cl. H02J 3/46; H02J 3/32; H02J 7/00

(52) U.S. Cl. CPC H02J 3/46; H02J 3/32; H02J 7/52; H02J 7/82; H02J 2101/40

(57) ABSTRACT

An energy storage system includes a plurality of energy storage banks connected in parallel to a trunk line, and a system management device. When a maximum voltage difference between the energy storage banks is equal to or greater than a first threshold before the energy storage banks are caused to input to the trunk line, the system management device executes a process of mitigating a cross current generated between the energy storage banks to mitigate a cross current accompanying the inputting to the trunk line by the energy storage banks. When the maximum voltage difference between the energy storage banks is less than the first threshold, the system management device causes the energy storage banks to input to the trunk line without limitation of the process of mitigating the cross current.

### CROSS REFERENCE TO RELATED APPLICATIONS

This application is a National Stage Application, filed under 35 U.S.C. § 371, of International Application No. PCT/JP2023/035338, filed Sep. 28, 2023, which international application claims priority to and the benefit of Japanese Application No. 2022-155976, filed Sep. 29, 2022; the contents of both of which are hereby incorporated by reference in their entirety.

### BACKGROUND

### Technical Field

The present invention relates to a technique for suppressing a cross current at the time of inputting to a trunk line in an energy storage system that includes a plurality of energy storage modules.

### Description of Related Art

In recent years, energy storage systems for residential, industrial, and energy management applications have been widely used to achieve energy saving. The energy storage part of the energy storage system includes a plurality of energy storage banks connected in parallel. Japanese Patent No. 6790949 is a document that discloses this type of technique.

### BRIEF SUMMARY

There is a voltage difference between the energy storage banks due to variations in initial state of charge (SOC) or the like. When there is a voltage difference between the energy storage banks, a cross current flows between the energy storage banks when each energy storage bank is caused to input to a trunk line after the installation work of the energy storage system. If the cross current exceeds a limit value, a defect, such as failure of an energy storage bank or a protective device, may occur, and it has been required to suppress the cross current to less than the limit value.

An object of the present invention is to suppress a cross current generated between energy storage banks at the time of inputting to a trunk line in an energy storage system that includes a plurality of energy storage banks connected in parallel.

The energy storage system includes a plurality of energy storage banks connected in parallel to the trunk line, and a system control device.

When the maximum voltage difference between the energy storage banks is equal to or greater than a first threshold before each of the energy storage banks is caused to input to the trunk line, the system control device executes a process of mitigating a cross current generated between the energy storage banks to mitigate a cross current accompanying the inputting to the trunk line by each of the energy storage banks. When the maximum voltage difference between the energy storage banks is less than the first threshold, the energy storage banks are caused to input to the trunk line without limitation of the process of mitigating the cross current.

According to the present technique, in an energy storage system including a plurality of energy storage banks connected in parallel, it is possible to suppress a cross current generated between the energy storage banks at the time of inputting to the trunk line.

### BRIEF DESCRIPTION OF THE FIGURES

FIG. 1A is a schematic view of inputting by energy storage banks.

FIG. 1B is an equivalent circuit of the energy storage banks.

FIG. 2 is a table illustrating voltage differences enabling inputting.

FIG. 3 is the equivalent circuit of the energy storage banks.

FIG. 4 is the equivalent circuit of the energy storage banks.

FIG. 5 is a diagram illustrating the order of inputting by the energy storage banks.

FIG. 6 is a diagram illustrating the order of inputting by the energy storage banks.

FIG. 7 is a diagram illustrating the order of inputting by the energy storage banks.

FIG. 8 is a block diagram illustrating a system configuration of the energy storage system.

FIG. 9 is a block diagram of an energy storage module.

FIG. 10 is a view illustrating an energy storage module and a sensor unit.

FIG. 11 is an inputting sequence by energy storage banks.

FIG. 12A is a simulation result (illustrating a voltage change in a trunk line).

FIG. 12B is a simulation result (illustrating voltage changes in banks).

FIG. 12C is a simulation result (illustrating current changes in banks).

FIG. 13A is a simulation result (illustrating a voltage change in a trunk line).

FIG. 13B is a simulation result (illustrating voltage changes in banks).

FIG. 13C is a simulation result (illustrating current changes in banks).

FIG. 14 is a diagram illustrating the order of inputting by the energy storage banks.

FIG. 15 is an inputting sequence by the energy storage banks.

FIG. 16 is a flowchart of an on-bank preliminary warning process.

FIG. 17 is a table summarizing the correspondence between a case in which an on-bank is present and a case in which an on-bank is not present before execution of a cross-current mitigation process.

### DETAILED DESCRIPTION OF VARIOUS EMBODIMENTS

(1) An energy storage system according to one embodiment of the present invention includes a plurality of energy storage banks connected in parallel to a trunk line, and a system control device. When the maximum voltage difference between the energy storage banks is equal to or greater than a first threshold before each of the energy storage banks is caused to input to the trunk line, the system control device executes a process of mitigating a cross current generated between the energy storage banks to mitigate a cross current accompanying the inputting to the trunk line by each of the energy storage banks. When the maximum voltage difference between the energy storage banks is less than the first threshold, the energy storage banks are caused to input to the trunk line without limitation of the process of mitigating the cross current.

The energy storage system according to one embodiment of the present invention can achieve the following effects. When the maximum voltage difference between the energy storage banks is higher than the first threshold, a cross current may be generated between the energy storage banks and exceed a limit value at the time of inputting to the trunk line. According to this energy storage system, in the above case, the cross current generated between the energy storage banks can be suppressed to be less than the limit value by the process of mitigating the cross current. Therefore, it is possible to suppress the occurrence of defects in the energy storage bank, a protective device thereof, and the like. Further, when the maximum voltage difference between the energy storage banks is less than the first threshold, the energy storage banks are caused to input to the trunk line without limitation of the process of mitigating the cross current, enabling the inputting work by the energy storage banks to be completed in a short time.

(2) In the energy storage system described in (1) above, when the maximum voltage difference between the energy storage banks is equal to or greater than a second threshold that is higher than the first threshold, the system control device may calculate a voltage difference between each of the energy storage banks with respect to a reference bank, using an energy storage bank having a lowest voltage or an energy storage bank having a highest voltage as the reference bank, exclude an energy storage bank having the calculated voltage difference equal to or greater than the second threshold, and determine an order of inputting to the trunk line by the energy storage banks.

According to the energy storage system described in (2) above, at the initial stage of the inputting work, for example, when the number of energy storage banks caused to input to the trunk line is one, the energy storage bank that cannot be expected to mitigate the cross current is excluded, and inputting work to the trunk line by the other energy storage banks can be performed while the cross current is suppressed.

(3) In the energy storage system described in (2) above, the system control device may calculate the number of energy storage banks to be excluded from the determination of the order of inputting for both a case in which the energy storage bank having the lowest voltage is used as the reference bank and a case in which the energy storage bank having the highest voltage is used as the reference bank, and select as the reference bank the energy storage bank in the case where the number of energy storage banks to be executed is smaller.

According to the energy storage system described in (3) above, the number of energy storage banks excluded from the determination of the order of inputting can be reduced, and more energy storage banks can be included in the target for the process of mitigating the cross current.

(4) In the energy storage system according to any one of (1) to (3) above, the process of mitigating the cross current may be a process of estimating the cross current between the energy storage banks in every predetermined time based on measured values of a current and a voltage of each of the energy storage banks, and causing each of the energy storage banks to input to the trunk line after the estimated value of the cross current becomes less than the limit value.

According to the energy storage system described in (4) above, the energy storage bank can be caused to input to the trunk line at timing when the cross current falls below the limit value.

(5) In the energy storage system described in (4) above, after executing the process of mitigating the cross current, the system control device may stop the process of mitigating the cross current when the measured value of the current of the energy storage bank is less than a predetermined value despite the estimated value of the cross current being equal to or greater than the limit value.

According to the energy storage system described in (5) above, it is possible to suppress the process of estimating the cross current from being repeated even though the estimated value of the cross current is unlikely to fall below the limit value.

Hereinafter, the process of mitigating a cross current I between energy storage banks B will be described.

### 1. Calculation of Voltage Difference Enabling Inputting

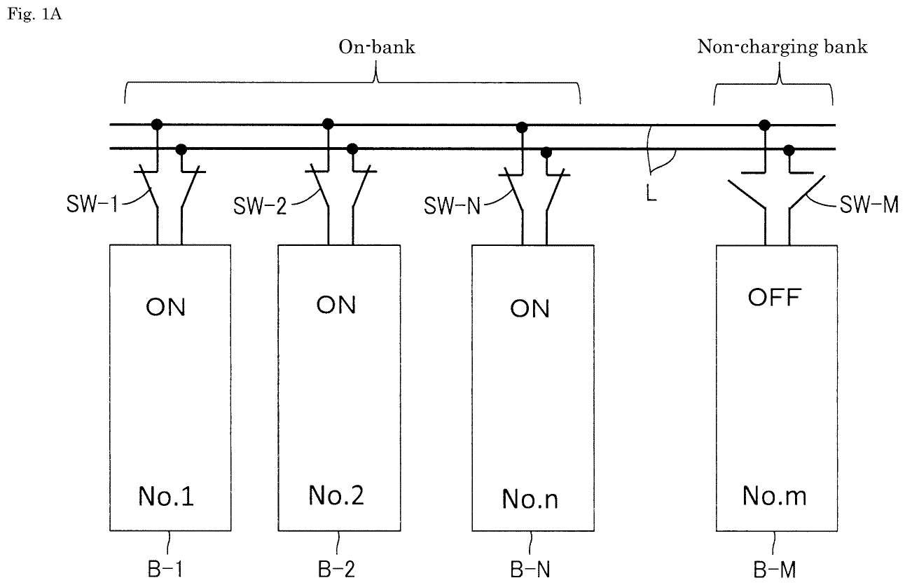

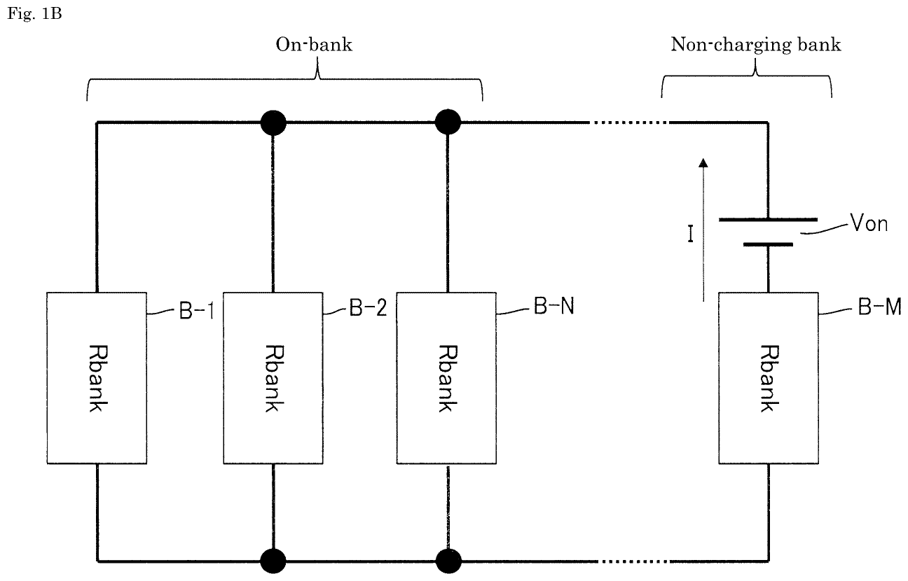

FIG. 1 is a schematic diagram of an energy storage system S and an equivalent circuit thereof. The energy storage system S includes M energy storage banks B-1, B-2, . . . , B-M connected in parallel. Hereinafter, the energy storage bank B is simply referred to as a bank B.

Each bank B is connected to a trunk line L via a switch SW. Each bank B is caused to input to a trunk line L by closing the switch SW and is disconnected from the trunk line L by opening the switch SW.

With a bank B that has already input to the trunk line L as an on-bank B and a bank B to input to the trunk line L as an inputting bank B, the relationship of a voltage difference Von between the on-bank B group and the inputting bank B and the cross current I can be calculated by Mathematical Expression 1. The cross current I is a current generated between the banks (a current flowing between the on-bank and the inputting bank) due to the voltage difference between the banks at the time of inputting by the banks.

$$V on = ( \frac{R b a n k}{N o n} + R b a n k ) \times I \qquad [ Math . 1 ]$$

Rbank is the resistance of the bank B (the number of series×the internal resistance of the cell), the contact resistance of the switch SW, and wiring resistance. Non is the number of on-banks before inputting. I is a cross current (a current flowing between the banks). Note that the first term on the right side of Mathematical Expression 1 is the combined resistance of the on-bank B group, and decreases as the number of on-banks increases.

2 Determination of Range of Voltages that Enable Inputting

The voltage difference Von between a non-inputting bank B and the on-bank B, which enables the non-inputting bank B to perform inputting, can be calculated by Mathematical Expression 1 from the following conditions.

Isys(MAX) is a rated current of an energy storage system S1. The case of “enabling inputting” is a case where the cross current I does not exceed the rated current Isys(MAX). The rated current Isys(MAX) corresponds to the “limit value” of the present invention.
Conditions (1200V system)
Von: The voltage difference between the non-inputting bank B and the on-bank B
group before inputting.
Rbank: 210 mΩ
Non: 1 to 57

$$Isys ( MAX ) = 50 A$$

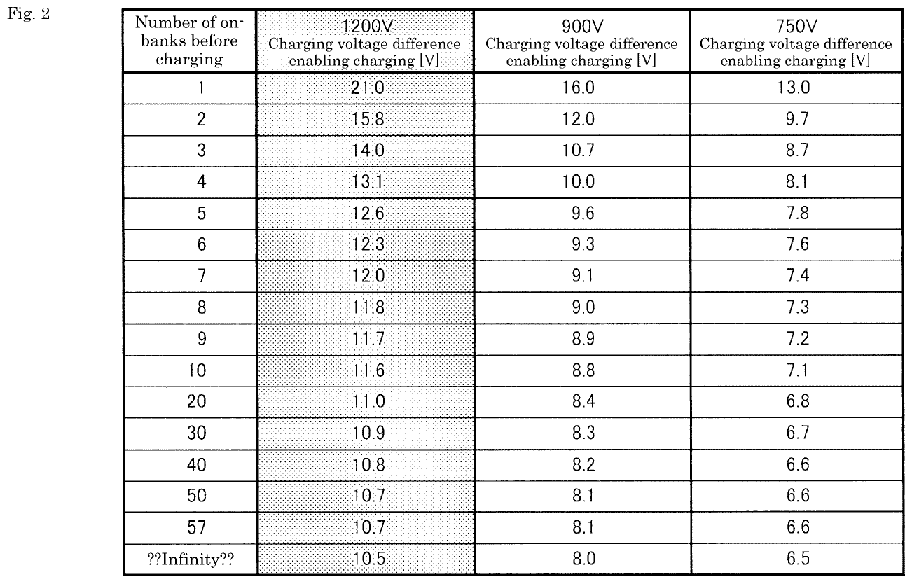

As illustrated in FIG. 2, the voltage difference Von enabling inputting varies depending on the number of on-banks, and the greater the number of on-banks, the lower the voltage difference Von. In addition, in the case of the 1200V system, when the voltage difference Von between the bank B and the on-bank B group is less than 10.5 [V], the cross current I is less than the rated current regardless of the number of on-banks before inputting, and inputting can be performed.

When the voltage difference Von is 10.5 [V] or more, the cross current I may exceed the rated current depending on the number of on-banks. In the calculation, when the number of on-banks=1 and the voltage difference between the on-bank B and the non-inputting bank B is 21 [V] or more, the cross current I cannot be suppressed below the rated current. Therefore, when the number of on-banks=1, the upper limit voltage difference that enables the bank B to input to the trunk line L is 21 [V].

Hereinafter, a first threshold V1 is a voltage difference between the on-bank B group and the non-inputting bank B, which enables the non-inputting bank B to input to the trunk line L regardless of the number of on-banks before inputting. In the present embodiment, the first threshold V1=10.5 [V]. V1=10.5V is an example, and other numerical values may be used.

A second threshold V2 is an upper limit voltage difference between the on-bank B and the non-inputting bank B, which enables the non-inputting bank B to input to the trunk line L when the number of on-banks before inputting=1. In the present embodiment, the second threshold V2=21 [V]. V2=21V is an example, and other numerical values may be used. However, V2>V1.

### 3. Cross-Current Mitigation Process

The cross-current mitigation process for mitigating the cross current I between the banks B accompanying the input to the trunk line L will be described using the 1200V system as an example.

As described above, when a voltage difference V between the on-bank B and the non-inputting bank B is 10.5 [V] or more, the cross current I may exceed a rated current of 50 [A]. Therefore, the cross current I at the time of inputting is estimated by calculation, and based on the estimation result, it is determined whether the non-inputting bank B can be caused to input to the trunk line L.

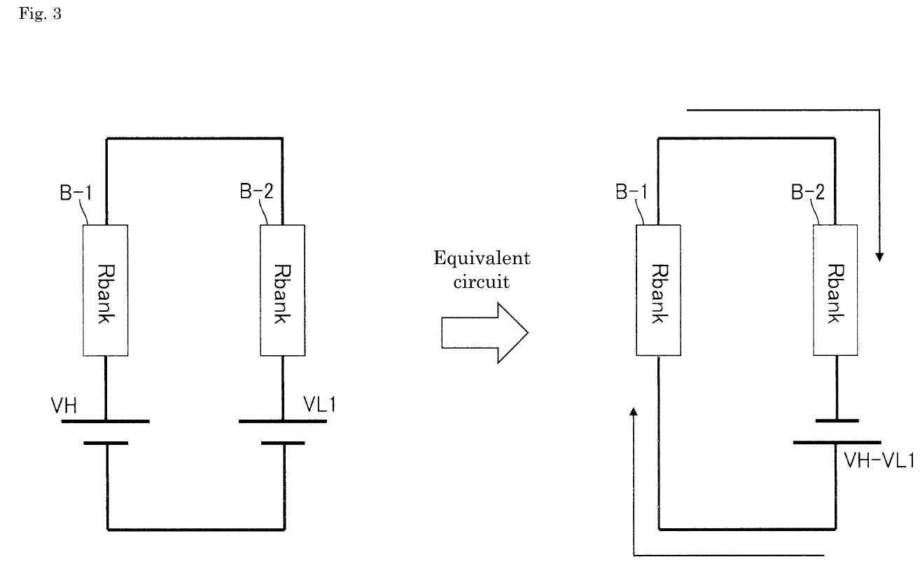

FIG. 3 illustrates an equivalent circuit of the bank B when the second bank B-2 is caused to inputting (one on-bank) after the inputting by the first bank B-1. At the time of inputting by the second bank B-2, a voltage difference VH−VL1 between the banks with which the cross current I is equal to or less than the rated current of 50 [A] is as follows. VH is the voltage of the bank B-1 having a high voltage, and VL1 is the voltage of the bank B-2 having a low voltage.

$$\frac{V H - V L 1}{R b a n k + R b a n k} < 50 A \qquad [ Math . 2 ]$$

$$\begin{matrix}V H - V L 1 < 2 Rbank \times 50 A = 21. V \\ 2 Rbank = 410 m Ω\end{matrix} \qquad [ Math . 3 ]$$

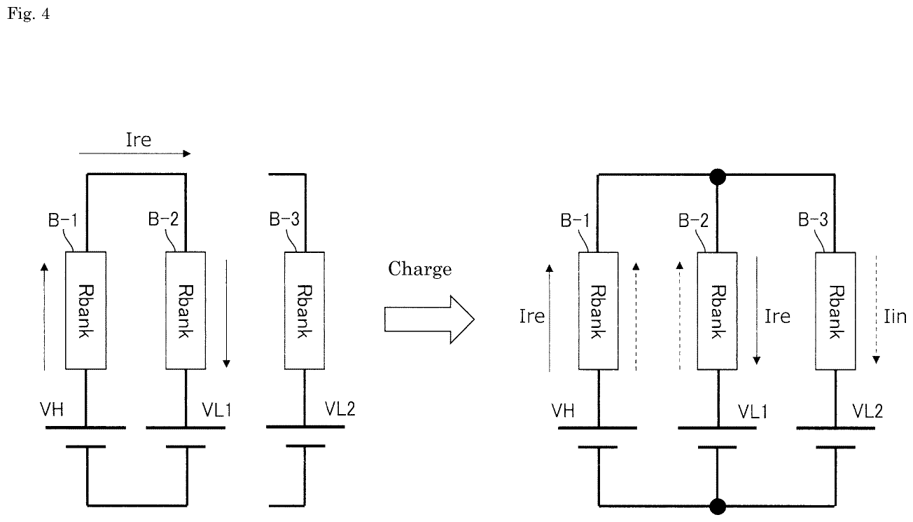

FIG. 4 illustrates an equivalent circuit of the bank B when the third bank B-3 is caused to inputting (the on-banks are B-1, B-2). After the inputting by the third bank B-3, a cross current Ion flowing to the on-banks B-1, B-2 and a cross current Iin flowing to the input third bank B-3 are as follows. Note that Ire is a cross current between the on-banks B-1, B-2 before inputting. Vdelta is a measured value of the voltage difference between an average voltage (average of VH and VL1) of the on-banks B-1, B-2 and a voltage VL2 of the non-inputting bank B-3.

$$Ion = Ire + \frac{V delta}{( \frac{R b a n k}{2} + R b α n k )} \times \frac{1}{2} \qquad [ Math . 4 ]$$

$$Iin = \frac{- V delta}{( \frac{R b a n k}{2} + R b a n k )} \qquad [ Math . 5 ]$$

The cross current Ion of the on-banks B-1, B-2 and the cross current Iin of the bank (inputting bank) B-3 that inputs to the trunk line L need to be set to equal to or less than the rated current of 50 [A] in this set system.

In the cross-current mitigation process disclosed in the present specification, the bank B is caused to perform inputting according to the following (1) to (5).

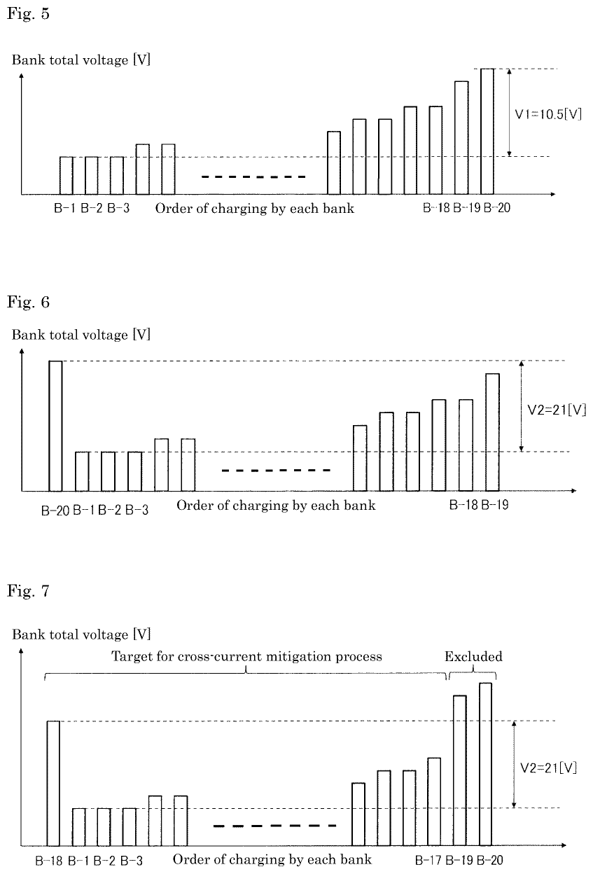

(1) As illustrated in FIG. 5, the banks B-1 to B-20 are ordered in ascending order of the total voltage.

(2) As illustrated in FIG. 6, the bank B-20 having the highest voltage is caused to input first.

(3) As illustrated in FIG. 6, the bank B-1 having the lowest voltage is caused to input second.

(4) Among the non-inputting banks, the cross currents Ion, Iin when the bank B having a low voltage is caused to input are estimated by the following Mathematical Expression 6 and Mathematical Expression 7, and after the estimated values of the cross currents Ion, Iin become less than the rated current Isys, the bank B is caused to input to the trunk line L.

(5) (4) is repeatedly performed.

$$Isys ( max ) < Ion = Ir e + \frac{V delta}{( \frac{Rban k}{N o n} + R b a n k ) \times N o n \times ( 1 - S )} < + Isys ( max ) \qquad [ Math . 6 ]$$

$$- Isys ( max ) < Iin = \frac{- V delta}{( \frac{R b a n k}{Non} + R b a n k ) \times ( 1 - S )} < + Isys ( max ) \qquad [ Math . 7 ]$$

Mathematical Expression 6 is an estimation equation for the cross current Ion of the on-bank B group, and Mathematical Expression 7 is an estimation equation for the cross current Iin of the inputting bank B. The cross currents Ion, Iin can be estimated by substituting the measured value of the voltage difference Vdelta between the on-bank B group and the non-inputting bank B and the measured value of the cross current Ire before inputting into Mathematical Expressions 6 and 7.

Isys(max)=50 [A], and Rbank uses the measured values of the resistance of the bank B (the number of series×the internal resistance of the cell), the contact resistance of the switch SW, and wiring resistance. S is a safety margin (S<1).

### First Embodiment

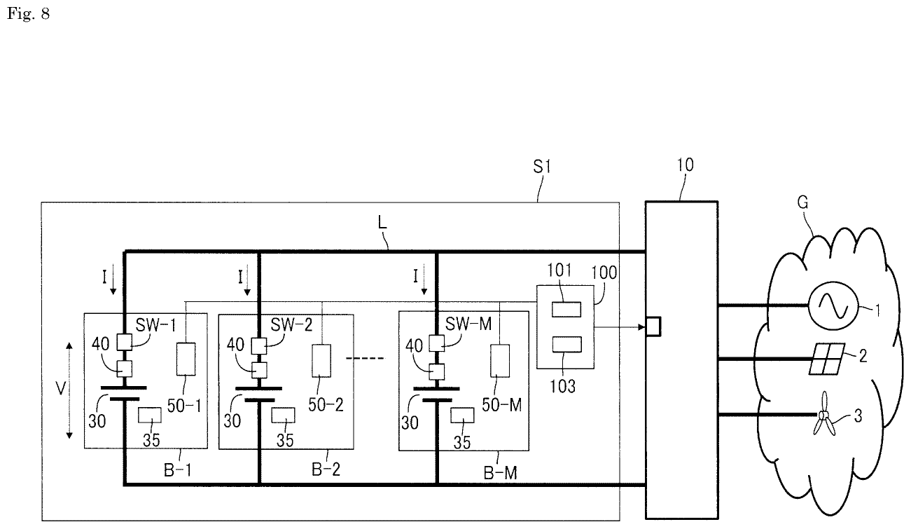

FIG. 8 is a block diagram of the energy storage system S1. The energy storage system S1 is connected to a grid G via a power conditioner 10. The grid G includes a system power supply 1, a solar power generation panel 2, and a distributed power supply 3, such as a wind power generator, and supplies AC power to the energy storage system S1 and a demand facility (not illustrated) at a commercial frequency.

The power conditioner 10 is a bidirectional power converter and can convert alternating current (AC) power of the grid G into direct current (DC) power to charge the energy storage system S1. In addition, DC power supplied from the energy storage system S1 can be converted into AC power and output to the grid G.

The energy storage system S1 can be used in various applications, such as residential, industrial, and energy management. The energy storage system S1 can contribute to the efficient use of energy by charging with the surplus power of the grid G and discharging according to the supply and demand balance of power.

The energy storage system S1 includes a plurality of banks and includes banks B-1 to B-M, bank management devices 50-1 to 50-M, and a system management device 100.

Each of the banks B-1 to B-M is connected in parallel to the power conditioner 10 via the trunk line L. Switches SW-1 to SW-M, such as relays, are provided in the banks B-1 to B-M, respectively.

By closing each switch SW, the bank B can be caused to input to the trunk line L. By opening each switch SW, the bank B can be disconnected from the trunk line L The banks B-1 to B-M have the same configuration.

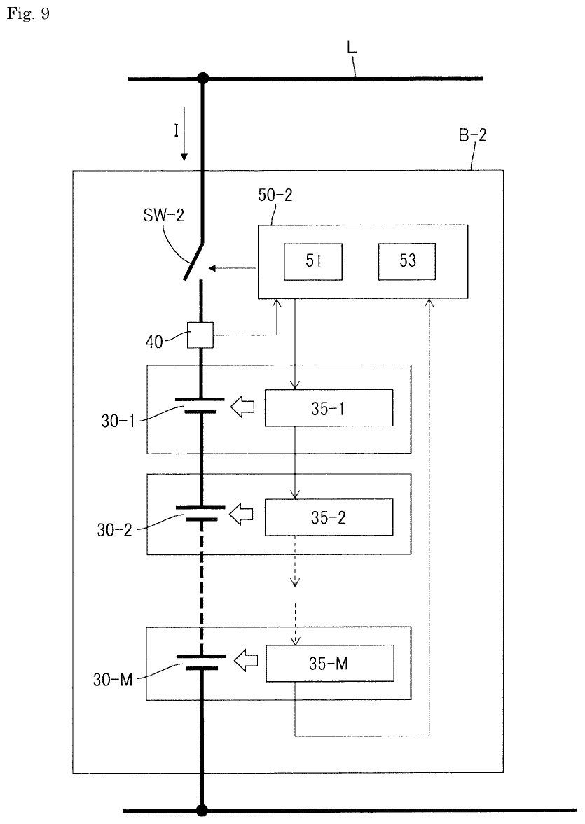

As illustrated in FIG. 9, the bank B includes a plurality of energy storage modules 30-1, 30-2, 30-M, a plurality of sensor units 35-1, 35-2, 35-M, a switch SW, and a current sensor 40 connected in series.

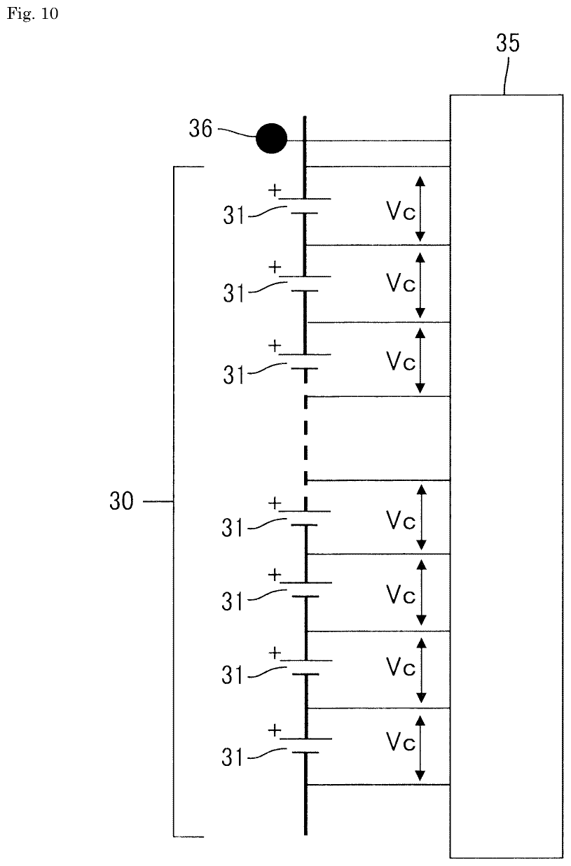

As illustrated in FIG. 10, one energy storage module 30 includes a plurality of energy storage cells 31 connected in series. As the energy storage cell 31, a lithium ion secondary battery cell or the like can be used.

The sensor unit 35 is provided for each energy storage module 30. The sensor unit 35 detects a cell voltage Vc of each energy storage cell 31. The sensor unit 35 includes a temperature sensor 36 and also detects a battery temperature T of the energy storage module 30.

As illustrated in FIG. 9, the sensor unit 35 is communicably connected to the adjacent sensor unit 35. In response to an instruction from the bank management device 50, data can be transmitted in order from the upper-level sensor unit 35 to the lower-level sensor unit 35, enabling the measurement results of the sensor units 35 to be aggregated at the lowest-level sensor unit 35M and transmitted to the bank management device 50

The bank management devices 50-1 to 50-M are provided for the banks B-1 to B-M, respectively. Each of the bank management devices 50-1 to 50-M includes a calculation part 51, such as a central processing unit (CPU), and a storage part 53.

Based on various data transmitted from the sensor unit 35 and the current sensor 40, each of the bank management devices 50-1 to 50-M monitors the total voltage V of the bank B (the total voltage of all the energy storage modules 30 to 1 to 30-M), the bank current I, the cell voltage Vc of each energy storage cell 31, and the battery temperature T. The bank B is caused to input to or is disconnected from the trunk line L by controlling the opening and closing (open or closed) of the switch SW.

The bank management devices 50-1 to 50-M are connected to the system management device 100. The system management device 100 includes a calculation part 101, such as a CPU, and a storage part 103.

The system management device 100 monitors the state of the entire system based on the monitoring data on the banks B-1 to B-M (the data on the total voltage V of each bank B, the bank current I, and the battery temperature T), which are transmitted from the bank management devices 50-1 to 50-M.

### 2. Cross-Current Mitigation Process

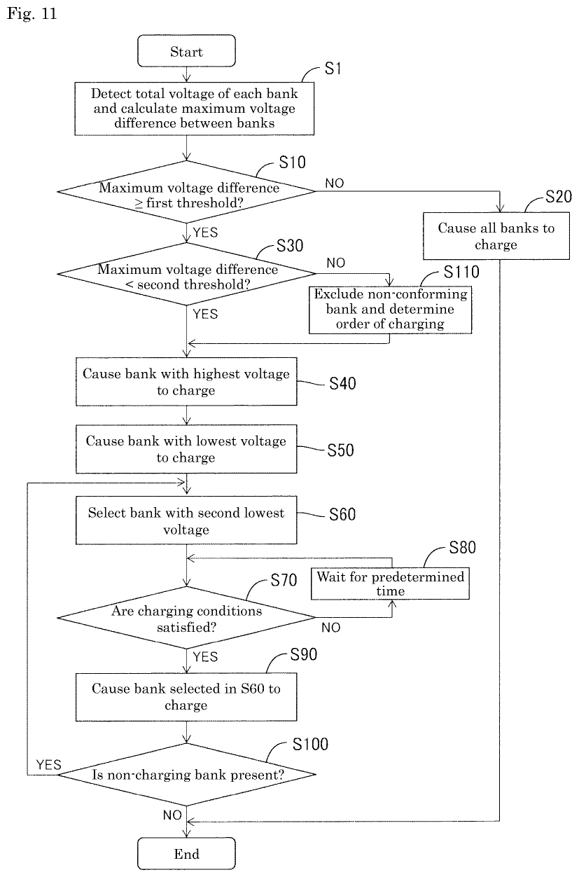

FIG. 11 illustrates an inputting sequence for the trunk line L by the bank B.

The inputting sequence by the bank B is executed when the energy storage system S1 is carried in to a site and installation work is performed, that is, when the banks B-1 to B-M are caused to input to the trunk line L after the installation work of the energy storage system S1. At this time, the power conditioner 10 is stopped in a pre-operational state, and each of the banks B-1 to B-M is not in a state of charging and discharging the grid G and the load via the trunk line L and the power conditioner 10.

The inputting sequence by the bank B includes twelve steps S1 to S110. Hereinafter, the number of parallel connections of the bank B is set to 20 (M=20). First, in S1, the bank management devices 50-1 to 50-20 detect the total voltages V of the respective banks B-1 to B-20 (at this point, all of the non-inputting banks). Specifically, the sensor unit 35 measures the cell voltages Vc of the respective energy storage cells 31, and detects the total voltage V of each of the banks B-1 to B-20 based on the measurement result. When detecting the total voltages V of the respective banks B-1 to B-20, the bank management devices 50-1 to 50-20 transmit detection results of the total voltages V to the system management device 100. When receiving the data on the total voltages V of the banks B-1 to B-20 from the respective bank management devices 50-1 to 50-20, the system management device 100 compares the total voltages V of the respective banks B-1 to B-20 and calculates a maximum voltage difference ΔVm between the banks B. The maximum voltage difference ΔVm is a voltage difference between the bank B having the highest voltage and the bank B having the lowest voltage.

Thereafter, the process proceeds to S10, and the system management device 100 compares the maximum voltage difference ΔVm with the first threshold V1 and determines whether the maximum voltage difference ΔVm is equal to or greater than the first threshold V1. The first threshold V1 is a threshold for determining whether to execute the cross-current mitigation process, and in this example, V1=10.5V.

When the maximum voltage difference ΔVm between the banks B is less than the first threshold V1 (S10: NO), the cross current I does not exceed the rated current regardless of the order and timing of causing the banks B-1 to B-20 to perform inputting. Therefore, the process proceeds to S20, and the system management device 100 causes all the banks B-1 to B-20 to input to the trunk line L without limitation of the cross-current mitigation process. In the present embodiment, the system management device 100 transmits a command to each of the bank management devices 50-1 to 50-20 to sequentially close the switches SW-1 to SW-20, thereby sequentially causing the banks B-1 to B-20 to input to the trunk line L and completing the inputting work by the banks B-1 to B-20.

When the maximum voltage difference ΔVm between the banks B is equal to or greater than the first threshold V1 (S10: YES), the process proceeds to S30. When the process proceeds to S30, the system management device 100 compares the maximum voltage difference ΔVm between the banks B obtained in S10 with the second threshold V2, and determines whether the maximum voltage difference ΔVm is less than the second threshold V2.

The second threshold V2 is an upper limit value of the voltage difference ΔV between the banks B, which enables the cross current I to be suppressed to equal to or less than the rated current by the cross-current mitigation process when the number of on-banks=1. In this example, V2=21 [V].

When the maximum voltage difference ΔVm between the banks B is less than the second threshold V2 (S30: YES), the system management device 100 executes the cross-current mitigation process (S40 to S100) for all the banks B.

Specifically, first, in S40, the system management device 100 transmits a command to the bank management device 50, and causes the bank B (B-20 in this example) having the highest voltage among the non-inputting banks B-1 to B-20 to input to the trunk line L. Thereafter, in S50, the bank B (bank B-1 in this example) having the lowest voltage among the non-inputting banks B-1 to B-20 is caused to input to the trunk line L (see FIG. 6). Since the two banks B-20, B-1 have the voltage difference ΔV, the cross current I flows between the two banks B-1, B-20 after the inputting by the second bank B-1.

Next, the process proceeds to S60, and the system management device 100 selects the bank B-2 having the lowest voltage among the non-inputting banks B-2 to B-19. Thereafter, the process proceeds to S70.

When the process proceeds to S70, the system management device 100 determines whether the bank B selected in S60 satisfies the following inputting conditions based on the data on the measured values of the bank current I and the total voltage V of the banks B.

### <Inputting Conditions>

(A) After the inputting by the selected bank, the cross current Ion of the on-bank B satisfies Mathematical Expression 6.

(B) After the inputting by the selected bank, the cross current Iin of the inputting bank B satisfies Mathematical Expression 7.

When the above inputting conditions are satisfied (S70: YES), the system management device 100 proceeds to S90 and causes the bank B selected in S60 to input to the trunk line L.

On the other hand, when the above inputting conditions are not satisfied (S70: NO), the process proceeds to S80 and waits for a predetermined time. Thereafter, the process proceeds to S70 to re-determine whether the inputting conditions are satisfied. By waiting for the elapse of the predetermined time, the cross current Ion generated between the first and second on-banks B gradually decreases and decreases. When the inputting conditions are switched from not satisfied to satisfied due to the decrease in the cross current Ion, the process proceeds to S90.

When the process proceeds to S90, the system management device 100 causes the bank B selected in S60 to input to the trunk line L.

Thereafter, the process proceeds to S100, and the system management device 100 determines the presence or absence of the non-inputting bank B. When a non-inputting bank B is present, the process proceeds to S60, and the above process is repeated. Then, when a non-inputting bank B is no longer present, NO is determined in S100, and the series of processes ends.

When the maximum voltage difference ΔVm between the banks B calculated in S10 is equal to or greater than the second threshold V2 (S30: NO), the system management device 100 proceeds to S110, and calculates the voltage difference ΔV between each bank B with respect to the reference bank B using the bank B having the lowest voltage as the reference bank. Then, the bank B having the voltage difference ΔV greater than the second threshold V2 is excluded, and the order of inputting by the banks B is determined.

In the example of FIG. 7, the bank B-1 has the lowest voltage, and the banks B-19, B-20, which have a voltage difference ΔV from the bank B-1 greater than the second threshold V2, are excluded. Then, the order of inputting is determined for the banks B-1 to B-18, which have a voltage difference ΔV from the bank B-1 less than the second threshold V2.

The order of inputting is the order of the banks B having lower voltages, following the first bank B having the highest voltage and the second bank B. In this example, the order of inputting by B-18, B-1, B-2, . . . , B-16, and B-17 is determined.

After the order of inputting is determined in S110, the first bank B-18 is caused to input to the trunk line in S40, and the second bank B-1 is caused to input to the trunk line L in S50. Thereafter, the processes of S60 to S100 are performed according to the order of inputting determined in S110 until a non-inputting bank B is no longer present. When a non-inputting bank B is no longer present, NO is determined in S100, and the series of processes ends.

The two banks B-19, B-20 excluded from the determination of the order of inputting in S110 may be excluded from the cross-current mitigation process itself. Alternatively, after the completion of the inputting work for the trunk line L by the banks B-1 to B-18, which have not been excluded, the cross-current mitigation process may be performed again on the two banks to attempt to input to the trunk line L.

The reason for attempting to input to the trunk line by the two banks B-19, B-20, excluded from the determination of the order of inputting, is as follows: even if the inputting conditions of S70 are not satisfied due to a large voltage difference ΔV at the initial stage of the inputting work by the banks B, the voltage difference ΔV from the on-bank B group decreases caused by a rise in the voltage of the on-bank B group as the inputting work proceeds, and the inputting conditions of S70 may be satisfied. Voltage difference=the voltage difference between each of the excluded banks B-19, B-20 and the on-bank B group.

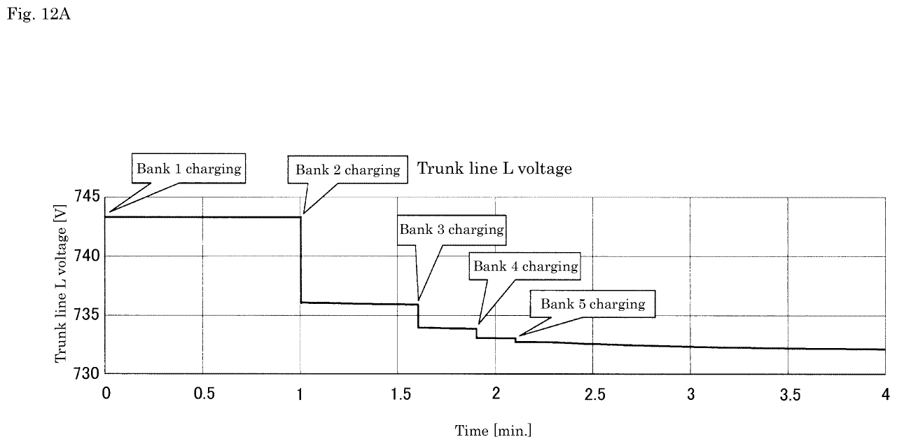

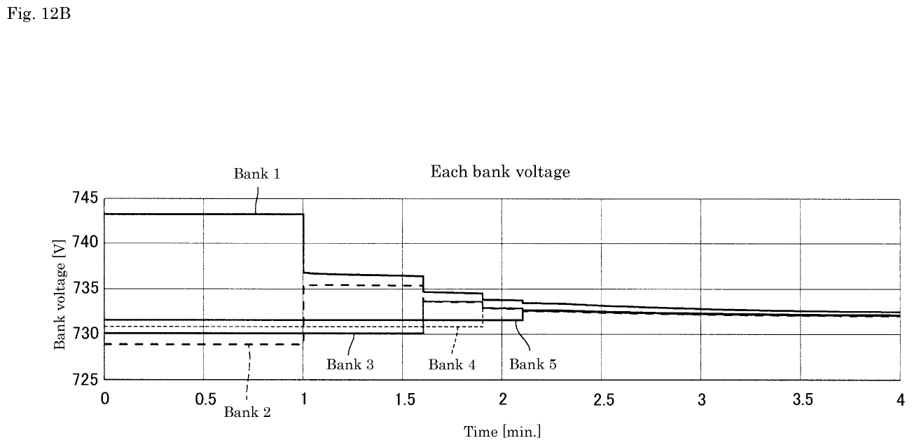

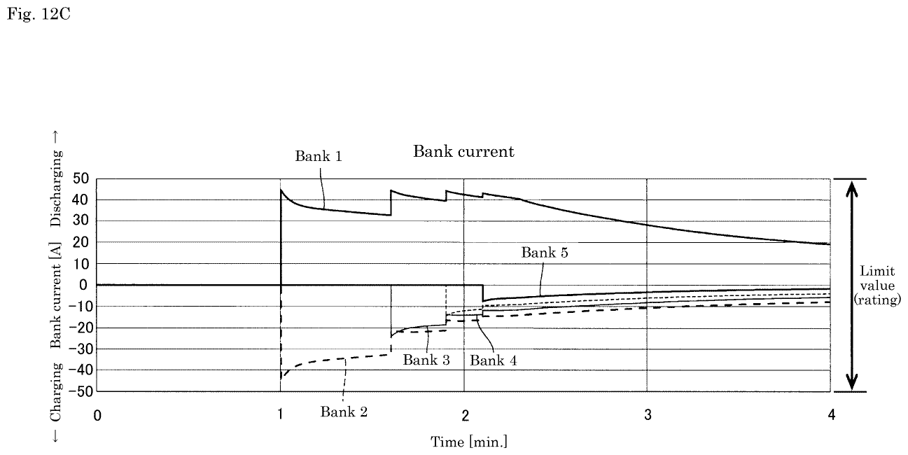

FIGS. 12A to 12C are results of Simulation 1 of the cross-current mitigation process. Conditions of Simulation 1 are as follows.

### <Simulation 1>

Number of banks: 5
Number of series: 15
System rated current: 50 A
Bank 1 voltage: 743.3V
Bank 2 voltage: 728.9V
Bank 3 voltage: 730.1V
Bank 4 voltage: 730.8V
Bank 5 voltage: 731.6V
Safety margin: 10%
Maximum voltage difference between banks: 14.4V
First threshold 7.2V
Second threshold 14.4V

In Simulation 1, as illustrated in FIG. 12A, the bank 2 having the lowest voltage is caused to perform inputting when one minute has elapsed after the inputting by the bank 1 having the highest voltage. After the inputting by the bank 2, a cross current is generated between the banks 1, 2 due to a voltage difference ΔV between the bank 1 and the bank 2. Immediately after the inputting by the bank 2, the cross current Ion is large, and in this state, the inputting conditions for the next bank 3 are not satisfied. However, the cross current Ion decreases with the lapse of time, and in due course, the inputting conditions for the next bank 3 are satisfied, and the next bank 3 is caused to perform inputting. Similarly, the bank 4 and the bank 5 are caused to perform inputting after the inputting conditions are satisfied. As illustrated in FIG. 12C, in Simulation 1, the current I of each of the banks 1 to 5 was suppressed to less than the system rated current (50 A), enabling the effect to be confirmed.

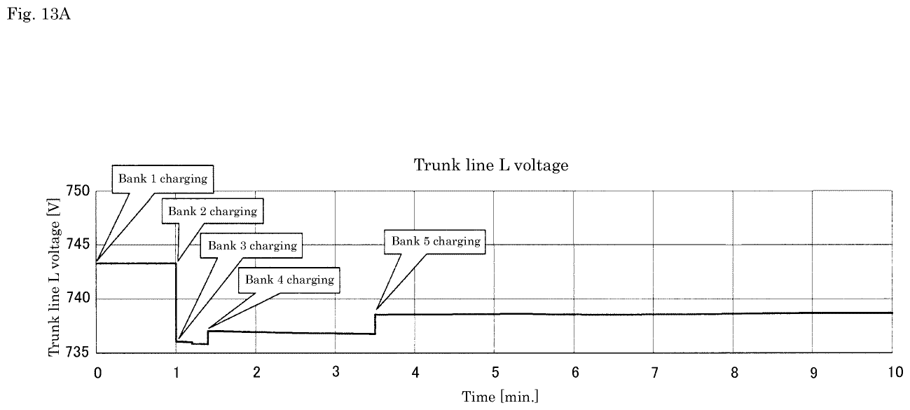

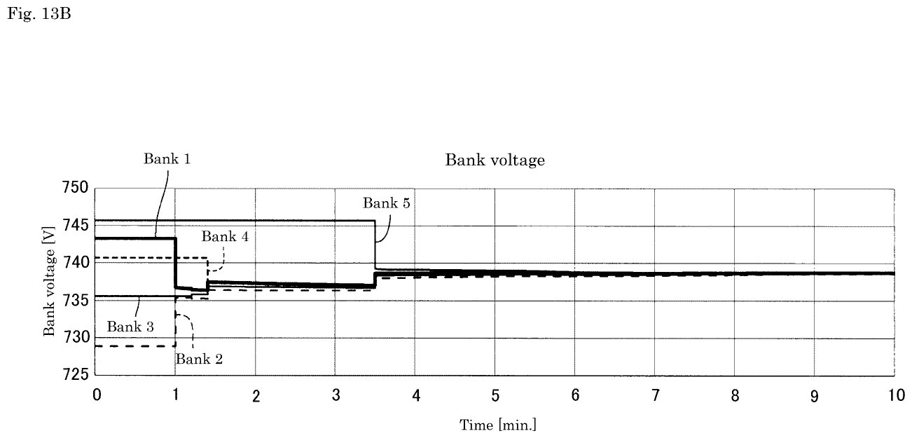

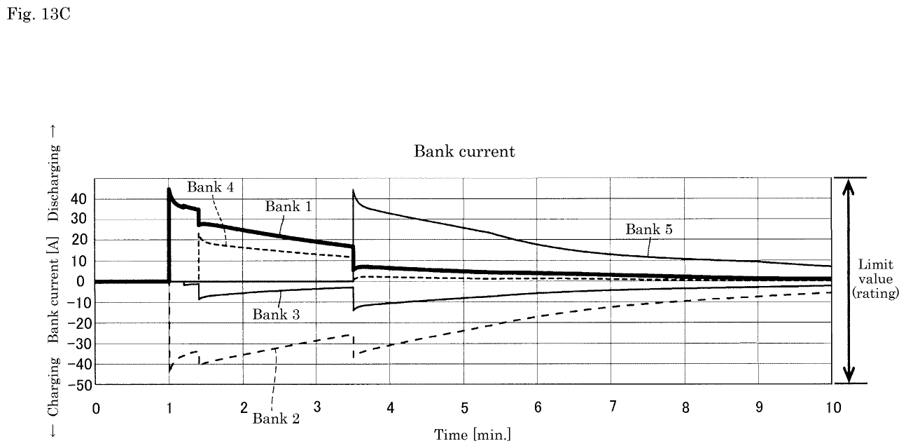

FIGS. 13A to 13C are results of Simulation 2 of the cross-current mitigation process. Conditions of Simulation 2 are as follows.

### <Simulation 2>

Number of banks: 5
Number of series: 15
System rating: 50 A
Bank 1 voltage: 743.3V
Bank 2 voltage: 728.9V
Bank 3 voltage: 735.6V
Bank 4 voltage: 740.7V
Bank 5 voltage 745.7V
Safety margin: 10%
Maximum voltage difference between banks: 16.8V
First threshold 7.2V
Second threshold 14.4V

In Simulation 2, in a state before the start of the cross-current mitigation process, the voltage difference ΔV between the bank 5 and the bank 2 was equal to or greater than the second threshold 14.4 [V], and the bank 5 was out of the target range for the cross-current mitigation process. However, as illustrated in FIGS. 13B and 13C, the banks 1 to 4 were caused to perform inputting, and after the inputting by the banks 1 to 4, the voltage difference ΔV between the on-banks 1 to 4 and the bank 5 became less than the second threshold 14.4 to satisfy the inputting conditions for the bank B, making it possible for the bank 5 to finally input to the trunk line L.

The following may apply to the bank B that is initially out of the target range for the cross-current mitigation process: since the voltage of the on-bank group B changes due to inputting by the bank B (rises with an increase in the number of times of inputting in the present embodiment), after the start of the inputting work by the bank B, the inputting conditions are satisfied as the number of times of inputting by the bank B increases, enabling the bank B, initially out of the target range, to input to the trunk line L.

### 3. Effects

According to the energy storage system S1 disclosed in the present specification, when the maximum voltage difference ΔVm between the banks B is higher than the first threshold V1 and the cross current I generated between the banks B may exceed the limit value (rated current) at the time of inputting to the trunk line L (S10: YES), the mitigation process (S40 to S100) for mitigating the cross current I is executed, so that it is possible to suppress the cross current I exceeding the limit value from flowing between the banks.

Therefore, when the bank B is caused to input to the trunk line L, it is possible to suppress the occurrence of defects in the bank B, the protective device thereof, and the like. When the maximum voltage difference ΔVm between the banks is in a predetermined range (V1≤ΔVm<V2), the bank B can automatically be caused to input to the trunk line L. Therefore, monitoring the inputting state of the bank B during the inputting work is unnecessary, providing the advantage of reducing the monitoring burden on an operator. Furthermore, when the maximum voltage difference ΔVm between the banks B is less than the first threshold V1 (S10: NO), all the banks B are caused to input to the trunk line L without limitation of the mitigation process for mitigating the cross current I, enabling the inputting work by the bank B to be completed in a short time.

### Second Embodiment

In the first embodiment, in the inputting sequence by the bank B illustrated in FIG. 11, when the maximum voltage difference ΔVm between the banks calculated in S1 is equal to or greater than the second threshold V2 (S30: NO), the system management device 100 sets the bank B having the lowest voltage as a reference (B-1 in the example of FIG. 7), and excludes the bank B, which has a voltage difference ΔV from the reference bank B-1 greater than the second threshold V2 (excludes B-19 and B-20 in the example of FIG. 7). Then, the system management device 100 determines the order of inputting to the trunk line L by the banks B for the banks B, which have a voltage difference ΔV from the reference bank B-1 less than the second threshold V2 (B-1 to B-18 in the example of FIG. 7).

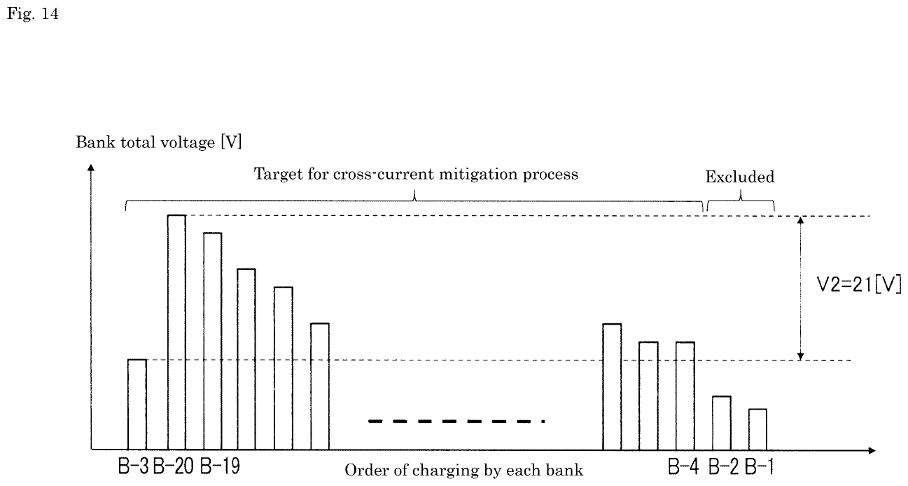

In the second embodiment, in the inputting sequence by the bank B illustrated in FIG. 11, when the maximum voltage difference ΔVm between the banks calculated in S1 is equal to or greater than the second threshold V2 (S30: NO), the system management device 100 sets the bank B having the highest voltage as the reference bank (the bank B-20 in the example of FIG. 14), and excludes the bank B, which has the voltage difference ΔV from the reference bank B-20 greater than the second threshold V2 (excludes the banks B-1 and B-2 in the example of FIG. 14). Then, the system management device 100 determines the order of inputting to the trunk line L by the banks B for the banks B (B-3 to B-20 in the example of FIG. 14), which have a voltage difference ΔV from the reference bank B-20 less than the second threshold V2.

Which one of the bank B-1 having the lowest voltage or the bank B-20 having the highest voltage is selected as the reference bank may be determined by the following method. The number of banks B to be excluded from the determination of the order of inputting may be calculated for both a case in which the bank B-1 having the lowest voltage is used as the reference bank and a case in which the bank B-20 having the highest voltage is used as the reference bank, and the bank B in the case where the number of banks B to be executed is smaller may be selected as the reference bank.

As a result, the number of banks B excluded from the determination of the order of inputting can be reduced, and more banks B can be included in the target for the cross-current mitigation process.

### Third Embodiment

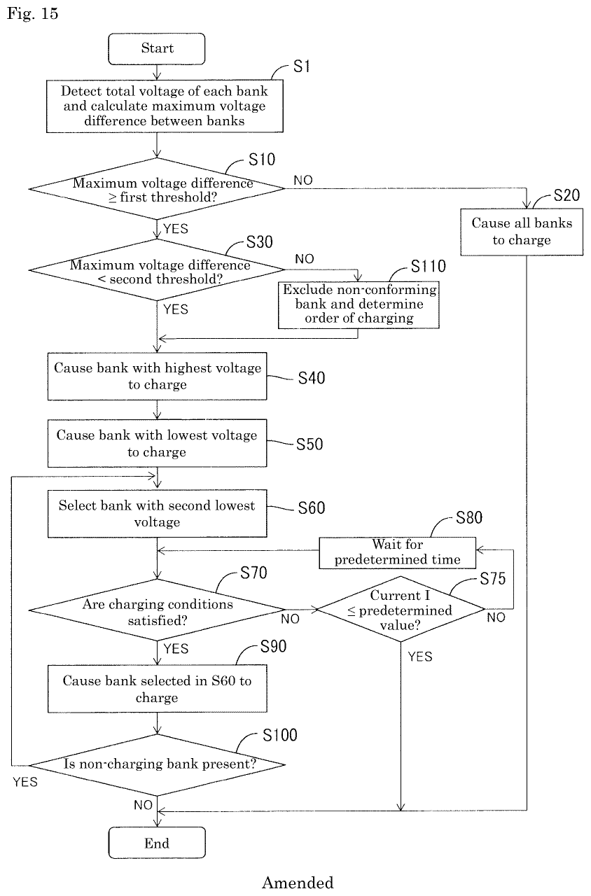

FIG. 15 is an inputting sequence for the trunk line L by the bank B. In the inputting sequence of FIG. 15, S75 is added to the inputting sequence illustrated in FIG. 7. S75 is executed when NO is determined in S70.

When the process proceeds to S75, the system management device 100 compares the current I of each on-bank B with a predetermined value and determines whether the current I of the on-bank B is equal to or less than the predetermined value. The predetermined value is, for example, 2 [A].

When the current I of the on-bank B is larger than the predetermined value (S75: NO), the system management device 100 determines that the voltage difference ΔV between the banks may decrease with the lapse of time and the inputting conditions may be satisfied. Then, the process proceeds to S80. When the process proceeds to S80, after waiting for a predetermined time, the process proceeds to S70 to re-determine whether the inputting conditions are satisfied.

When the current I of the on-bank B is equal to or less than the predetermined value (S75: YES), the system management device 100 does not expect a decrease in the voltage difference ΔV between the banks with the lapse of time, and determines that there is no possibility of the inputting conditions being satisfied. In this case, the system management device 100 ends the inputting sequence by the bank B.

By adding S75, it is possible to suppress S70, S75, and S80 from being repeated even though the inputting conditions of S70 are unlikely to be satisfied. As one of the cases where YES is determined in S75, a case in which S70 is performed on the bank B excluded in S110 is considered.

### Fourth Embodiment

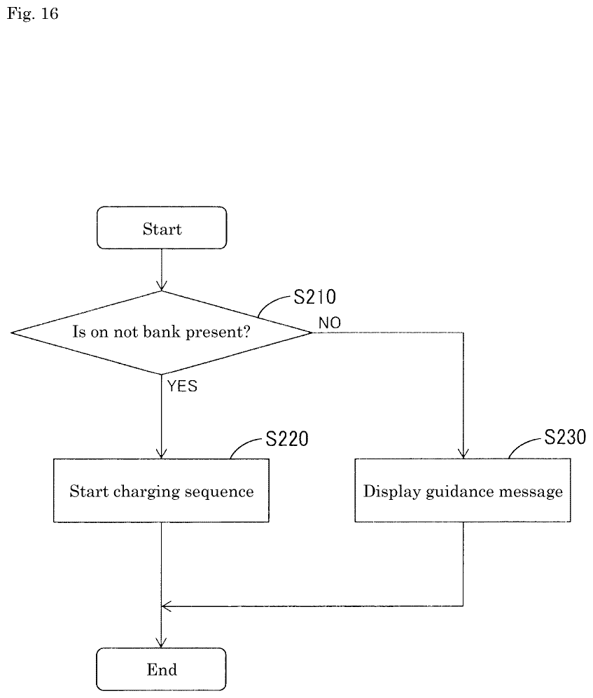

FIG. 16 is a flowchart of an on-bank preliminary warning process.

The on-bank preliminary warning process is a process performed before the execution of the inputting sequence illustrated in FIGS. 11 and 15, and includes S210 to S230.

In S210, the system management device 100 determines whether the on-bank B that has input to the trunk line L is present. The presence or absence of the on-bank B can be determined based on the states of the switches SW-1 to SW-20 of the banks B-1 to B-20.

When an on-bank B is not present (S210: YES), the system management device 100 starts the inputting sequence illustrated in FIGS. 11 and 15.

When an on-bank B is present (S210: YES), the system management device 100 displays a guidance message requesting disconnection of the on-bank B on a display part provided in the energy storage system S1.

After the display of the guidance message, when the system management device 100 confirms that the on-bank B has been disconnected from the trunk line L by the operator and the on-bank B is not present, the system management device 100 then starts the inputting sequence illustrated in FIGS. 11 and 15.

With this configuration, it is possible to prevent the start of the inputting sequence in a state where the on-bank B is already present.

### Fifth Embodiment

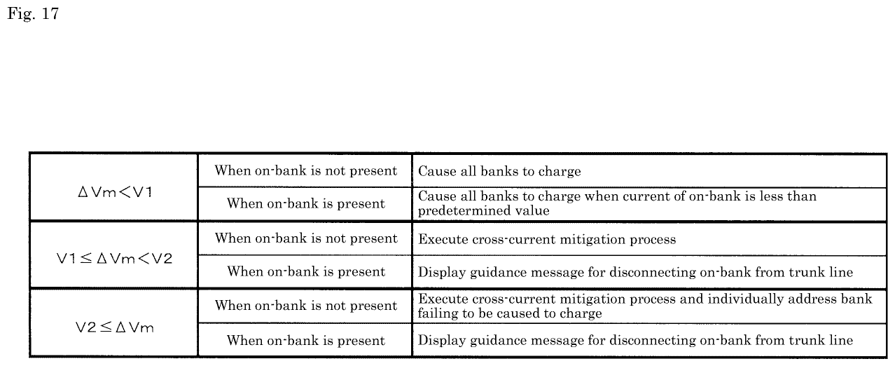

FIG. 17 is a table summarizing the correspondence between a case in which an on-bank is present and a case in which an on-bank B is not present before the execution of the cross-current mitigation process.

When the Maximum Voltage Difference Between Banks B is Smaller Than the First Threshold (ΔVm<V1)

When an on-bank B is not present, the system management device 100 causes all the banks B to input to the trunk line L. When an on-bank B is present, and when the current of the on-bank B is less than a predetermined value (e.g., less than 2 [A]), all the banks B are caused to input to the trunk line L. When the current I of the on-bank B is equal to or greater than the predetermined value, the inputting by the bank B is stopped.

This is because when the current I of the on-bank B exceeds the predetermined value, a current may be flowing to or from another energy storage system S or a power system, and if the bank B is caused to input to the trunk line L in such a situation, the cross current I generated between the banks B may exceed the rated current.

When the Maximum Voltage Difference Between the Banks B is Equal to or Greater Than the First Threshold and Less Than the Second Threshold (V1≤ΔVm<V2)

When an on-bank B is not present, the system management device 100 executes the cross-current mitigation process. When an on-bank B is present, a guidance message for disconnecting the on-bank B from the trunk line L is displayed.

When the Maximum Voltage Difference Between the Banks B is Equal to or Greater Than the Second Threshold (V2≤ΔVm)

When an on-bank B is not present, the system management device 100 executes the cross-current mitigation process, and individually address banks B failing to be caused to input to the trunk line L. When an on-bank B is present, a guidance message for disconnecting the on-bank B from the trunk line L is displayed.

### OTHER EMBODIMENTS

The present invention is not restricted to the embodiments described above and the drawings, but, for example, the following embodiments are also included in the technical scope of the present invention.

(1) In the above embodiments, the bank having the highest voltage has been first caused to input to the trunk line L, and the bank B having the lower voltage is subsequently caused to input to the trunk line L. The order of inputting by the banks B may be reversed. That is, the bank B having the lowest voltage may be first caused to input to the trunk line L, and the bank B having the higher voltage may be sequentially caused to input to the trunk line L.

(2) The energy storage cell is not limited to a lithium ion secondary battery cell but may be another nonaqueous electrolyte secondary battery or a lead-acid battery. A capacitor may be used instead of the energy storage cell.

1. An energy storage system comprising:
a plurality of energy storage banks connected in parallel to a trunk line; and
a system control device,
wherein
when a maximum voltage difference between the energy storage banks is equal to or greater than a first threshold before each of the energy storage banks is caused to input to the trunk line, the system control device executes a process of mitigating a cross current generated between the energy storage banks to mitigate a cross current accompanying the inputting to the trunk line by each of the energy storage banks, and
when the maximum voltage difference between the energy storage banks is less than the first threshold, the energy storage banks are caused to input to the trunk line without limitation of the process of mitigating the cross current.

2. The energy storage system according to claim 1, wherein,
when the maximum voltage difference between the energy storage banks is equal to or greater than a second threshold that is higher than the first threshold, the system control device calculates a voltage difference between each of the energy storage banks with respect to a reference bank, using an energy storage bank having a lowest voltage or an energy storage bank having a highest voltage as the reference bank, excludes an energy storage bank having the calculated voltage difference equal to or greater than the second threshold, and determines an order of inputting to the trunk line by the energy storage banks.

3. The energy storage system according to claim 2, wherein the system control device calculates the number of energy storage banks to be excluded from the determination of the order of inputting for both a case in which the energy storage bank having the lowest voltage is used as the reference bank and a case in which the energy storage bank having the highest voltage is used as the reference bank, and selects as the reference bank the energy storage bank in the case where the number of energy storage banks to be executed is smaller.

4. The energy storage system according to claim 1, wherein
the process of mitigating the cross current is a process of estimating the cross current between the energy storage banks in every predetermined time based on measured values of a current and a voltage of each of the energy storage banks, and causes each of the energy storage banks to input to the trunk line after the estimated value of the cross current becomes less than a limit value.

5. The energy storage system according to claim 4, wherein
after executing the process of mitigating the cross current, the system control device stops the process of mitigating the cross current when the measured value of the current of the energy storage bank is less than a predetermined value despite the estimated value of the cross current being equal to or greater than the limit value.

6. An energy storage bank inputting method comprising:
executing a process of mitigating a cross current generated between the energy storage banks when a maximum voltage difference between the energy storage banks is equal to or greater than a first threshold before each of the energy storage banks is caused to input to a trunk line, to mitigating a cross current accompanying the inputting to the trunk line by the energy storage bank, and
causing the energy storage bank to input to the trunk line without limitation of the process of mitigating the cross current when the maximum voltage difference between the energy storage banks is less than the first threshold.
